(19) United States
(12) Patent Application Publication
(10) Pub. No.: US 2024/0101808 A1
(43) Pub. Date: Mar. 28, 2024

(54) Anti-Sticking Perfluoroelastomer Articles and Methods of Making

(71) Applicant: 3M INNOVATIVE PROPERTIES COMPANY, St. Paul, MN (US)

(72) Inventors: Yuta Suzuki, Sagamihara-shi (JP); Tatsuo Fukushi, Woodbury, MN (US)

(21) Appl. No.: 18/262,140

(22) PCT Filed: Feb. 17, 2022
(86) PCT No.: PCT/IB2022/051426

§ 371 Date: Jul. 19, 2023

Related U.S. Application Data
(60) Provisional application No. 63/150,332, filed on Feb. 17, 2021.

(51) Int. Cl. C08L 27/18; B29C 35/02; B29C 71/02

(52) U.S. Cl. CPC C08L 27/18; B29C 35/02; B29C 71/02; B29L 2007/001; C08L 2205/025

(57) ABSTRACT

Methods of making anti-sticking perfluorinated articles are described. The methods include molding curing, and heat-treating a composition prepared from a coagulated and dried blend of latex dispersions of a perfluoro-elastomeric gum and a perfluoroplastic. The curing steps are performed at temperatures below the melting point of the perfluoroplastic, while the heat-treatment step occurs at a temperature above this melting point. The resulting articles are also described.

### FIELD

The present disclosure relates to methods of making an anti-sticking fluoroelastomer article and the resulting articles. The articles are made from a blend of a fluoro-elastomeric gum and a perfluoroplastic. The blend is molded and cured below the melting point of the perfluoroplastic, then heat-treated at a temperature above the melting point. The resulting articles show a perfluoroplastic-rich region at their surfaces providing reduced sticking.

### SUMMARY

Briefly, in one aspect, the present disclosure provides methods of making a fluoroelastomer article comprising molding a composition into a shape, the composition comprising a coagulated and dried latex blend comprising
(a) a perfluoro-elastomeric gum comprising, based on the total moles of repeat units in the gum, 0.5 to 4 mole % of repeat units of a curesite monomer, 46 to 80 mole % of tetrafluoroethylene repeat units, and 16 to 50 mole % of perfluoro ether repeat units selected from the group consisting of perfluorovinyl ethers, perfluoroallyl ethers, and combinations thereof, provided that the total amount of tetrafluoroethylene and perfluoro ether repeat units is at least 96 mole % of the total moles of repeat units in the perfluoro-elastomeric gum; and
(b) a perfluoroplastic having a melting point of at least 290° C., the perfluoroplastic comprising, based on the total moles of repeat units in the perfluoroplastic, at least 85 mole % tetrafluoroethylene repeat units, and 1.5 to 12 mole % of perfluoro ether repeat units selected from the group consisting of perfluorovinyl ethers, perfluoroallyl ethers, and combinations thereof. The composition is then cured using one or more curing steps to form a cured structure comprising the cured perfluoroelastomer, wherein each curing step occurs at a curing temperature below the melting point of the perfluoroplastic. The cured structure is then heat-treated at a heat-treatment temperature of at least 5° C. above the melting point of the perfluoroplastic for a heat-treating time of at least 5 minutes to form the fluoroelastomer article.

In another aspect, the present disclosure provides cured fluoroelastomer articles having a core surrounded by surface, the article comprising
(a) a cured perfluoro-elastomeric gum comprising, based on the total moles of repeat units in the gum, 0.5 to 4 mole % of repeat units of a curesite monomer, 46 to 80 mole % of tetrafluoroethylene repeat units, and 16 to 50 mole % of perfluoro ether repeat units selected from the group consisting of perfluorovinyl ethers, perfluoroallyl ethers, and combinations thereof, provided that the total amount of tetrafluoroethylene and perfluoro ether repeat units is at least 96 mole % of the total moles of repeat units in the perfluoro-elastomeric gum; and
(b) a perfluoroplastic having a melting point of at least 290° C., the perfluoroplastic comprising, based on the total moles of repeat units in the perfluoroplastic, at least 85 mole % tetrafluoroethylene repeat units, and 1.5 to 12 mole % of perfluoro ether repeat units selected from the group consisting of perfluorovinyl ethers, perfluoroallyl ethers, and combinations thereof. The cured perfluoro-elastomeric gum and the perfluoroplastic are present through-out the core of the article, the perfluoroplastic is present at the surface of the article, and the surface comprises dimples having an average diameter of 5 to 50 microns.

Other features, objects, and advantages of the invention will be apparent from the description and from the claims.

### BRIEF DESCRIPTION OF THE DRAWINGS

FIG. 1 is an SEM image of the surface of the O-ring of CE-1.

FIG. 2 is an SEM image of the surface of the O-ring of EX-1.

### DETAILED DESCRIPTION

Perfluoropolymers have superior thermal, chemical and plasma resistance compared to non-fluorinated and partially fluorinated polymers. These properties allow perfluoropolymers to be used in a wide variety of demanding applications. For example, perfluoropolymers, particularly, perfluoroelastomers, have been used as sealing materials in manufacturing operations, e.g., in equipment used to manufacture semiconductors.

Despite their advantages, some properties of perfluoroelastomers can make their use more challenging. For example, the surface of perfluoroelastomer articles can be sticky or tacky. When used in sealing applications, the perfluoroelastomer is compressed between two substrates for an extended period of time, often at elevated temperatures. In some cases, the sticky nature of the elastomer surface results in adhesion of the fluoroelastomer seal to one or both substrates. This can result in the need for excessive force as well as damage to the seals when the substrates are later separated.

Prior approaches to address the stickiness of perfluoroelastomers have included the use of additives such as low molecular weight or low melting point materials, oils (e.g., silicone oils) and waxes; surface treatments such a plasma treatment or the application of crosslinkers or amines; and surface coatings such as silane coupling agents, reactive silicone resins, and amorphous fluoropolymer resins. Although such approaches have provided some level of anti-sticking behavior, further improvements are required. For example, the use of additives can result in off gassing or unwanted contaminants when the articles are used as seals in demanding applications. Also, surface treatments and surface coatings require additional steps and their use can result in bonding problems between the distinct layers.

The present disclosure provides perfluoroelastomer articles with improved anti-sticking properties. The articles are formed from a composition containing a perfluoro-elastomeric gum and a perfluoroplastic with a high melting temperature (Tm). Such compositions can then be formed (molded) into the desired article shape, e.g., a film or an O-ring. The shaped article is then subjected to one or more curing steps, each performed at temperatures below the melting temperature of the perfluoroplastic. Collectively, the times and temperatures of the curing steps are selected to cure (i.e., crosslink) the perfluoro-elastomeric gum to form the perfluoroelastomer. The cured article is then subjected to a heat-treatment step performed at a temperature above the melting temperature of the perfluoroplastic.

Compositions suitable for use in the methods of the present disclosure can be prepared by blending latex dispersions containing the perfluoro-elastomeric gum and the perfluoroplastic. This blended dispersion can then be coagulated, dried and compounded with a curative for the perfluoro-elastomeric gum.

As used herein, the term perfluoro refers to a material (whether a gum, elastomer or plastic) where at least 95 mol % of the hydrogen atoms of the backbone have been replaced by fluorine atoms. In some embodiments, at least 98 or even at least 99 mole % of these hydrogen atoms have been replaced by fluorine. The backbone refers to the main chain of the material including branches, as well as any pendant groups derived from perfluorinated monomers. However, the backbone of such materials excludes the end-groups, as well as the pendant portion of any cure site monomers.

As used herein, the term “perfluoro-elastomeric gum” refers to the uncured resin that, upon curing, e.g., with the aid of a curative, becomes the cured “perfluoroelastomer.” A perfluoroelastomer is a perfluorinated polymer that exhibits a glass transition temperature (Tg) of no greater than 25° C. In some embodiments, the Tg is no greater than 0° C., no greater than −25° C., or even no greater than −50° C.

Generally, the perfluoro-elastomeric gums comprise repeat units of tetrafluoroethylene (TFE), at least one perfluoro ether monomer, and a cure site monomer. As used herein a “repeat unit” refers to the unit in the gum or polymer derived from the recited monomer upon polymerization. For example, if a gum is referred to as comprising repeat units of TFE (CF₂═CF₂), the gum would contain repeat units of —[CF₂—CF₂]—.

The perfluoro ether monomers are ethylenically unsaturated and may be selected from the group consisting of perfluorovinyl ethers, perfluoroallyl ethers, and combinations thereof. Suitable perfluorovinyl ethers include perfluoroalkylvinyl ethers and perfluoroalkoxy vinyl ethers. Exemplary perfluoroalkyl and perfluoroalkoxy vinyl ethers include those where the alkyl or alkoxy group includes 1 to 8 carbon atoms, e.g., 1-6, or even 1-4 carbon atoms. In some embodiments, the perfluorovinyl ether is selected from the group consisting of perfluoromethyl vinyl ether, perfluoroethyl vinyl ether, perfluoropropyl vinyl ether, and combinations thereof.

Suitable perfluoroallyl ethers include perfluoroalkyl allyl ethers and perfluoroalkoxy allyl ethers. Exemplary perfluoroalkyl and perfluoroalkoxy allyl ethers include those where the alkyl or alkoxy group includes 1 to 8 carbon atoms, e.g., 1-6, or even 1-4 carbon atoms. In some embodiments, the perfluoroallyl ether is selected from the group consisting of perfluoromethyl allyl ether, perfluoroethyl allyl ether, perfluoropropyl allyl ether, and combinations thereof.

Generally, any known curesite monomer may be used. In some embodiments, the curesite monomer includes a bromine (Br) or iodine (I) curesite group. Exemplary curesite monomers include bromo- or iodo-(per)fluoroalkyl-(per)fluorovinyl ethers, and bromo- or iodo-containing (per)fluoroolefins. As used herein, (per)fluoro collectively refers to partially fluorinated a perfluorinated species.

In some embodiments, nitrile-group containing cure site monomers are preferred. Suitable nitrogen-containing cure site monomers include fluorinated vinyl ethers, including those of the following formulas: CF₂═CFO(CF₂)ᵤOCF(CF₃)CN, CF₂═CFO(CF₂)ᵥCN; CF₂═CFO[CF₂CF(CF₃)O]ₓ(CFO)_{y}CF(CF₃)CN; and wherein u=2 to 6, v=2 to 12, x=0 to 4, and y=0 to 6. Representative examples of cure site monomers include CF₂═CFO(CF₂)₅CN, CF₂═CFO(CF₂)₃OCF(CF₃)CN, and perfluoro(8-cyano-5-methyl-3,6-dioxa-1-octene).

Generally, the perfluoro-elastomeric gum comprises at least 0.5 mole % of curesite repeat units based on the total moles of repeat units. In some embodiments, the gum contains 0.5 to 4 mol %, e.g., 1 to 3, or even 1 to 2.5 mole % of curesite repeat units.

Generally, the perfluoro-elastomeric gums are copolymers of TFE and one or more ethylenically unsaturated perfluoro ether monomers. For example, at least 96 mole %, e.g., at least 97, or even at least 98 mole % of the repeat units in the perfluoro-elastomeric gum are TFE or perfluoro ether repeat units, based on the total moles of repeat units in the perfluoro-elastomeric gum. In some embodiments, the perfluoro-elastomeric gum comprises 46 to 80 mole % of TFE repeat units and 16 to 50 mole % of perfluoro ether repeat units based on the total moles of repeat units in the perfluoro-elastomeric gum.

A “perfluoroplastic” is a perfluorinated thermoplastic polymer. Suitable perfluoroplastics are based on tetrafluoroethylene and perfluorinated comonomer. Generally, the perfluoroplastic comprises at least 85 mol % of repeat unit of TFE. In some embodiments, the perfluoroplastic comprises at least 90 or even at least 95 mole % of TFE repeat units.

Suitable comonomers include perfluoro ether monomers that are ethylenically unsaturated and may be selected from the group consisting of perfluorovinyl ethers, perfluoroallyl ethers, and combinations thereof. Suitable perfluorovinyl ethers and perfluoroallyl ethers include those described herein with respect to the perfluoro-elastomeric gum.

The comonomer and the relative amounts of the monomers are selected to achieve a perfluoroplastic with a melting point of at least 290° C. In some embodiment, the melting point (Tm) is at least 300° C. or even at least 310° C. Generally, Tm is no greater than 320° C. For reference, homopolymers of TFE containing no greater than 1 mol % of a comonomer are generally referred to a PTFE and have a melting point of about 327° C.

Generally, the perfluoroplastic contains at least 1.5 mole % of repeat units of the perfluoro ether monomers, based on the total moles of repeat units in the perfluoroplastic. In some embodiments, the perfluoroplastic comprises at least 2, e.g., at least 3 mole % repeat units of the perfluoro ether monomers. In some embodiments, the perfluoroplastic comprises no greater than 12 mole %, e.g., no greater than 8 mole % repeat units of the perfluoro ether monomers.

In some embodiments, the perfluoroplastic includes repeat unit of a cure site monomer. Any known curesite monomer may be used including those described herein for the perfluoro-elastomeric gum. In some embodiments, nitrile-group containing cure site monomers are preferred. In some embodiments, the perfluoroplastic contains 0.1 to 1 mole % of cure site monomer repeat units, based on the total moles of repeat units in the fluoroplastic.

Both the perfluoro-elastomeric gum and the perfluoroplastic can be prepared as aqueous dispersions using known techniques. Generally, the Z-average particle size of the perfluoroplastic particles in the aqueous latex is no greater than 500 nm, e.g., no greater than 300 nm. In some embodiments, the Z-average particle size of the perfluoroplastic particles in the latex are between 20 and 500 nm, e.g., between 20 and 300 nm, or even between 50 and 250 nm, where all ranges are inclusive of their end points.

The Z-average particle size can be determined by means of dynamic light scattering with a Malvern Zetasizer 1000 HAS light scattering instrument in accordance to ISO/DIS 13321 (1996). Prior to the measurements, the polymer latexes or powders can be diluted or dispersed in a suitable dispersion media such as, e.g., 0.001 mol/L KCl-solution and the measurement temperature is 25° C. (referred to herein as the “Particle Size Method”).

The dispersions of the perfluoro-elastomeric gum and the perfluoroplastic can then be blended. Without wishing to be bound by theory, it is believed that blending the perfluoro-elastomeric gum with the latex of the perfluoroplastic particles results in a better distribution of the perfluoroplastic, while maintaining a small particle size. The resulting co-dispersion can then be coagulated, dried and compounded with the curative. Each of these steps is well known and any suitable techniques and equipment may be used.

As used herein, a curative refers to a material used to initiate or accelerate crosslinking, but which does not become part of the crosslinked polymer. This is in contrast to crosslinkers, which become integrated into the crosslinked polymer network. Generally, the curative for the perfluoro-elastomeric gum (and the perfluoroplastic, if needed) is not particularly limited. The curative can be selected based on the curesite monomer(s) selected, and the desired curing times and temperatures. In particular, the curing agent should be selected to achieve the desired level of cure at temperatures below the melting temperature of the perfluoroplastic.

The resulting composition can then be formed (e.g., molded or press-cured) into the desired article shape, e.g., a film, a seal, or an O-ring. The shaped article is then processed at a temperature and for a time sufficient to cure (i.e., crosslink) the perfluoro-elastomeric gum. The curing process may include one or more curing steps to ensure the desired level of cure in the finished perfluoroelastomer. Sometimes such additional steps are referred to as post-curing. In the methods of the present disclosure, each of these curing steps (including post-curing steps) are performed as a temperature below the melting point of the perfluoroplastic (Tm), e.g., at least 2° C. below Tm. In some embodiments, the maximum temperature used in the curing steps is at least 5° C. below Tm.

Following the curing steps, the cured article is heat-treated at a temperature above the melting temperature of the perfluoroplastic. In some embodiments, the heat-treatment temperature is at least 5° C. greater than Tm, e.g., at least 10° C. greater than Tm. Generally, higher temperatures may not be required or desired. Therefore, in some embodiments, the heat-treatment temperature is no more than 25° C., or even no more than 15° C. greater than Tm.

Generally, the cured article is heat-treated for at least for at least 5 minutes, e.g., at least 10, or even at least 15 minutes. Generally, there is no upper limit on the heat-treatment time; however, longer times can result in some degradation and unnecessary delays in production. In some embodiments, the heat-treatment time is no greater than 60 minutes, e.g., no greater than 40 minutes, or even no greater than 20 minutes.

Surprisingly, the present inventors discovered that this heat-treatment step can result in migration of the perfluoroplastic from the bulk to the surface of the article. The resulting surface has a matte/dimpled appearance, while samples prepared without heat treatment had a smooth glossy surface. In some embodiments, the surface comprises dimples randomly distributed across the surface. In some embodiments, the dimples have an average diameter of 5 to 50 microns, e.g., 5 to 30 microns, or even 10 to 20 microns. The average diameter can be determined from measurements taken from images, e.g., SEM images of the surface. For example, the average may be based on average diameter of 20 or 50 randomly selected dimples.

The matte/dimpled surface also had substantially lower sticking properties than articles prepared from the same compositions and subject to the same curing steps, but without the heat-treatment step. In some embodiments, the heat-treatment step can also result in a significant decrease in the coefficient of thermal expansion (CTE), which can be beneficial in a variety of applications.

### Examples

The materials used in the examples are summarized in Table 1. In the table and descriptions below, the following abbreviations are used: tetrafluoroethylene (TFE), perfluoromethylvinylether (PMVE), perfluoropropylvinylether (PPVE), 1,1,2,3,3-pentafluoro-3-(heptafluoro-propoxy)prop-1-ene (MA-3), and CF₂═CFO(CF₂)₅CN (MV5CN).

TABLE 1
Summary of materials used in the preparation of the examples.

| Name | Description |
|---|---|
| Gum-A | Aqueous latex of the following Perfluoro-elastomeric gum: |
| | TFE/PMVE/MV5CN (65.7/33.0/1.3 mole %);72.4 wt. % F content; |
| | Mooney Viscosity ML1 + 10 @ 121° C. of 95 |
| Gum-B | Aqueous latex of the following Perfluoro-elastomeric gum: |
| | TFE/PMVE/MV5CN (64.8/33.0/2.2 mole %); 72.2 wt. % F content; |
| | Mooney Viscosity ML1 + 10 @ 121° C. of 85 |
| PFP-A | Perfluoroplastic: TFE/PMVE/MA-3 (99.1/0.6/0.3 mole %) 75.9 wt. % F content |
| | Dry powder with a particle size of about 100 microns (μm) |
| PFP-B | Perfluoroplastic: TFE/PPVE (98.5/1.5 mole %) 75.8 wt. % F content |
| | Latex dispersion with a particle size of about 200 nanometers (nm) |
| PFP-C | Perfluoroplastic: TFE/PMVE/MA-3/MV5CN (99.0/0.6/0.3/0.1 mole %); |
| | 75.8 wt. % F content; Latex dispersion with a particle size of about 80 nm |
| PFP-D | Perfluoroplastic: TFE/PPVE/MV5CN (98.3/1.5/0.2 mole %); |
| | 75.7 wt. % F content; Dry powder with a particle size of about 100 μm |
| PFP-E | Perfluoroplastic: TFE/PMVE/MA-3/MV5CN (99.0/0.6/0.3/0.1 mole %) |
| | 75.8 wt. % F content; Dry powder with a particle size of about 100 μm |
| Blend-1 | 80 wt. % Gum-B and 20 wt. % PFP-C |
| Blend-2 | 80 wt. % Gum-A and 20 wt. % PFP-C |
| Blend-3 | 80 wt. % Gum-A and 20 wt. % PFP-B |
| Cur-A | Hydroxy-based curative |
| Cur-B | Adipate-based curative |

Sample Preparation Procedure. For each of the following samples, the identified latex or latex blend was coagulated and dried. If used, the catalyst was blended with the dried composition. The resulting composition was then molded into O-rings (AS-568-214, 3.53 mm thick with an inner diameter of 25 mm), press-cured at 180° C. for thirty minutes and cooled to room temperature. All samples were then post-cured using the following Curing Procedure:
Two-hour temperature ramp from room temperature to 150° C.,
Hold at 150° C. for seven hours
Two-hour temperature ramp from 150° C. to 300° C., and
Hold at 300° C. for two hours.
   Following the Curing Procedure, the samples were either (i) directly cooled to room temperature over a two-hour period, or (ii) heat-treated prior to being cooled to room temperature over a two-hour period. The Heat-Treatment Procedure consisted of a 15-minute temperature ramp from 300° C. to 320° C., then holding the sample at 320° C. for 15 minutes.

FT-IR Method. Fourier Transform Infrared Spectroscopy was performed on the O-ring samples using a Thermo Fisher Scientific Inc, model Nicolet iS50 FT-IR spectrometer. The spectrometer included a Diamond ATR (attenuated total reflectance) unit.

CTE Method. Samples were prepared according to the Sample Preparation Procedure, except that the samples were 2 mm thick blocks instead of O-rings. The samples were subjected to the same Curing and Heat-Treatment Procedures used for their corresponding O-ring samples. The coefficients of the thermal expansion (CTE) of the resulting samples were measured using a TA Instruments Inc, model Q400 thermomechanical analyzer. The samples were heated from −30° C. to 330° C. at 5° C. per min. in nitrogen (50 mL/minute) and analyzed using Probe geometry: Expansion and Base Force: 0.05 N. The CTE was calculated from the following formula:

$$\\ C T E = \frac{1}{L} \frac{dL}{dT}$$

where L is the test length, dL is the change in length, and dT is the change in temperature. The change in length (dL) was measured over the temperature range of 300 to 310° C., a dT of 10° C.

Sticking Force Method. The O-rings were put into a grove and compressed by 18% using a stainless steel plate (grade SUS316L). The compressed O-rings were heat-aged for 22 hours at 200° C. After cooling down to room temperature, the sticking force between O-rings and the stainless steel plate was measured using a model AGS-10kNX tensile tester from SHIMADZU CORPORATION. The test speed was 10 mm per minute.

Reference Samples. Reference samples were prepared from a perfluoro-elastomeric gum and a perfluoroplastic. For Reference Sample A (Ref-A), O-rings were prepared from a perfluoro-elastomeric gum (Gum A) according to the Sample Preparation Procedure using 0.5 parts by weight of curative Cur-A per 100 parts by weight of the perfluoro-elastomeric gum (i.e., 0.5 parts per hundred parts by weight resin, “0.5 phr”). Cur-A is a cure accelerator that does not become incorporated into the crosslinked polymer network. For Reference Sample B (Ref-B), O-rings were prepared from a perfluoroplastic (PFP-A) according to the Sample Preparation Procedure.

Ref-A and Ref-B were subjected to the Curing Procedure. Prior to cool-down, Ref-A was also subjected to the Heat Treatment Procedure. The resulting O-ring samples were then evaluated by the FT-IR Method. Ref-A, which consisted only of the perfluoroelastomer, showed a characteristic peak at 1189 cm⁻¹ at the surface of the O-ring. Ref-B, which consisted only of the perfluoroplastic, showed a characteristic peak at 1202 cm⁻¹ at the surface of the O-ring.

Comparative Example 1 (CE-1). O-rings were prepared from Blend-1 (80 wt. % Gum-B an 20 wt. % PFP-C) according to the Sample Preparation Procedure using 0.7 parts by weight of curative Cur-A per 100 parts by weight of the total weight of the perfluoro-elastomeric gum and the perfluoroplastic (i.e., 0.7 parts by weight per hundred parts by weight resin, “0.7 phr”). The molded O-rings were cured according the Curing Procedure with no heat-treatment prior to cooling to room temperature over two hours. Example 1 (EX-1) was prepared with the same materials and methods as CE-1, except that EX-1 was subjected to the Heat-Treatment Procedure.

The resulting O-rings were analyzed according to the FT-IR procedure, both within the core of the O-rings and at the surface of the O-rings. Both the core and the surface of CE-1 (no heat-treatment) showed a peak at about 1194 cm⁻¹, which lies between the peaks for Ref-A (fluoroelastomer) and Ref-B (fluoroplastic). Although the core of EX-1 showed a similar peak at 1193 cm⁻¹, the surface of EX-1 had a peak at 1202 cm⁻¹, characteristic of the fluoroplastic alone.

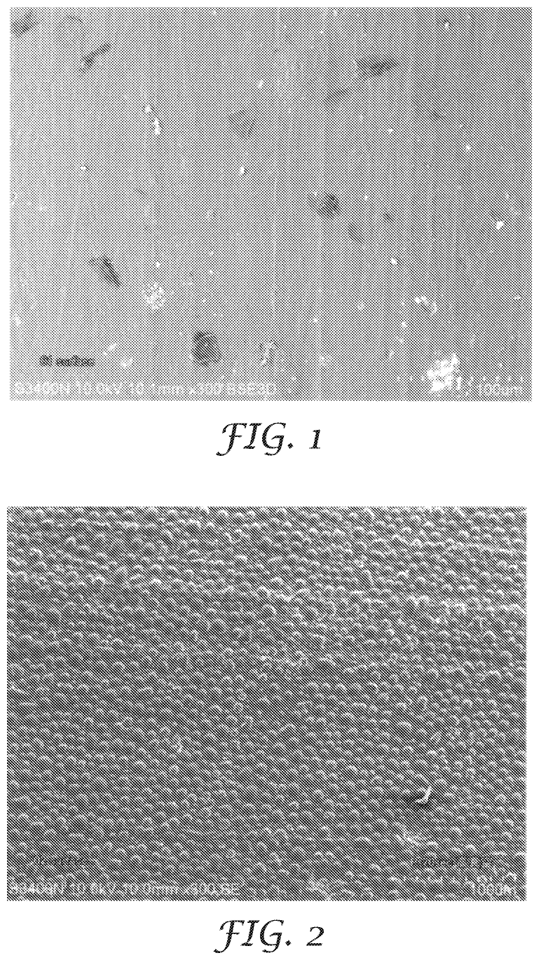

The O-rings were inspected, and SEM images of their surfaces were taken. As shown in FIG. 1, CE-1 had a smooth glossy surface. Also, the O-rings stuck to each other and the plastic bag in which they were stored, resulting in a rating of “Poor.” In contrast, the O-rings of EX-1 had a dimpled matte surface. As shown in FIG. 2, the dimples were about 10 to 20 microns in diameter and uniformly distributed across the surface of EX-1. The O-rings of EX-1 also showed much less adherence to each other and the plastic bag, resulting in a “Good.”

Articles prepared from the compositions and methods of CE-1 and EX-1 were also tested accord to the CTE Method (block samples) and the Sticking Force Method (O-ring samples). The results, along with the FTIR and surface analysis results, are summarized in Table 2. As shown, the heat-treatment resulted a substantial decrease in both CTE and sticking force.

TABLE 2
Test results for the O-rings of CE-1 and EX-1.

| | Peak (cm⁻¹) | | Surface | CTE | Force |
|---|---|---|---|---|---|
| Sample | Core | Surface | Analysis | μm/(m·° C.) | N |
| CE-1 | 1194 | 1195 | Glossy-poor | 1525 | 171 |
| EX-1 | 1193 | 1201 | Matte-good | 231 | 69 |

Additional samples were prepared by blending the latex of Gum A with varying amounts of latex Blend 2 (an 80:20 wt. % blend of Gum A and perfluoroplastic PFP-C) according to the ratios shown in Table 3. All samples were prepared according to the Sample Preparation Procedure using 0.5 phr of curative Cur-A. the samples were cured according the Curing Procedure, including the Heat-Treatment Procedure prior to the cooling step. The FT-IR Method was used to analyze the core and surface of each sample. These results, along with the surface analysis results, are show in Table 3.

TABLE 3
Test results for the O-rings with varying
amounts of perfluoroplastic.

| | Wt. % latex | | Wt. % solids | | | | |
|---|---|---|---|---|---|---|---|
| | Gum | Blend- | Gum- | PFP- | Peak (cm⁻¹) | | Surface |
| Sample | A | 2 | A | C | Core | Surface | analysis |
| CE-2 | 95 | 5 | 99 | 1 | 1188 | 1189 | Glossy - Poor |
| CE-3 | 90 | 10 | 98 | 2 | 1189 | 1190 | Glossy - Poor |
| CE-4 | 75 | 25 | 95 | 5 | 1190 | 1192 | Glossy - Poor |
| CE-5 | 50 | 50 | 90 | 10 | 1191 | 1192 | Glossy - Poor |
| EX-2 | 25 | 75 | 85 | 15 | 1192 | 1201 | Matte - Good |
| EX-3 | 0 | 100 | 80 | 20 | 1194 | 1201 | Matte - Good |

As shown, the characteristic peak at the core of all samples ranged from 1188 to 1994 cm⁻¹, increasing with increasing amounts of the perfluoroplastic. This indicates that, even with the heat-treatment step, the fluoroplastic remains present through-out the bulk of the article. The surfaces of comparative Examples CE-2 to CE-5, which contained 1 to 10 wt. % of the perfluoroplastic, showed similar characteristic peaks ranging from 1189 to 1192 cm⁻¹, indicating a uniform composition through-out the O-rings. In contrast, the surfaces of Examples EX-2 and EX-3, which contained 15 to 20 wt. % of the perfluoroplastic, showed a peak at 1201 cm⁻¹, characteristic of the perfluoroplastic itself. This indicates migration of some of the perfluoroplastic to create a perfluoroplastic-enriched surface layer. As shown in Table 3, this perfluoroplastic-enriched surface resulted in a matte appearance and less sticking, i.e., a “Good” rating as compared to the glossy appearance and undesirable stickiness of the comparative examples “Poor” rating).

Example 4 (EX-4) was prepared from Blend-3 (80 wt. % Gum-A and 20 wt. % PFP-B) according to the Sample Preparation Procedure using 0.7 phr of curative Cur-A. The material was cured according to the Curing Procedure, including the Heat-treatment Procedure. Similar to the other examples, the resulting O-rings showed a characteristic peak of 1192 cm⁻¹ at the core and 1202 cm⁻¹ at the surface. The O-rings had a matte surface were rated as “Good.”

Example 5 (EX-5) was prepared from Blend-2 (80 wt. % Gum-A and 20 wt. % PFP-C) according to the Sample Preparation Procedure using 7.5 phr of Cur-B. Like Cur-A, Cur-B is a cure accelerator that does not become incorporated into the crosslinked network. The material was cured according to the Curing Procedure, including the Heat-treatment Procedure. Similar to the other examples, the resulting O-rings showed a characteristic peak of 1193 cm⁻¹ at the core and 1201 cm⁻¹ at the surface. The O-rings had a matte surface were rated as “Good.”

### Comparative Examples 6 to 9

Samples CE-6 to CE-8 were prepared using Blend-2 according to the Sample Preparation Procedure. Sample CE-9 was prepared using Blend-1 according to the Sample Preparation Procedure. However, all these samples were prepare using 1.1 phr of an amidine crosslinker that becomes integrated into the crosslinked polymer. All samples were cured according to the Cure Procedure, but were subjected to various heat-treatment procedures, as summarized in Table 4. CE-6 and CE-9 were processed according the Heat-Treatment Procedure used for the previous samples, while CE-7 and CE-8 were heat-treated at a higher temperature and for longer times. The FT-IR and surface analysis results are also shown in Table 4.

TABLE 4
Summary of Comparative Examples CE-6 to CE-9, prepared using a crosslinker.

| | Heat-Treatment | Peak (cm⁻¹) | | Surface |
|---|---|---|---|---|
| Sample | Ramp and Hold | Core | Surface | analysis |
| CE-6 | 15-minute ramp from 300° C. to 320° C. then | 1193 | 1197 | Glossy- |
| | hold the sample at 320° C. for 15 minutes | | | Poor |
| CE-7 | 15-minute ramp from 300° C. to 325° C. then | 1193 | 1195 | Glossy- |
| | hold the sample at 325° C. for 2 hours | | | Poor |
| CE-8 | 15-minute ramp from 300° C. to 325° C. then | 1193 | 1194 | Glossy- |
| | hold the sample at 325° C. for 8 hours | | | Poor |
| CE-9 | 15-minute ramp from 300° C. to 320° C. then | 1193 | 1193 | Glossy- |
| | hold the sample at 320° C. for 15 minutes | | | Poor |

Sample CE-6 was also tested according to the Sticking Force Method resulting in a very high adhesion value of 301N.

Comparative Examples 10 to 12 (C-10 to CE-12) were prepared using perfluoroplastics in dry powder form rather than as aqueous latex dispersions. As shown in Table 1, the Z-average particle size of the dried powders was about 100 microns, which is several orders of magnitude larger than the particles of the aqueous latex dispersions (80 to 200 nm).

In addition, the aqueous latex dispersion of Gum A was coagulated and dried before compounding, and a dry compounding process was used. The dry perfluoroplastic powder was blended with the dried gum using a two roll mill. Curative Cur-A (0.7 phr) was also blended into the dry composition during this step. The resulting composition was then molded into O-rings (AS-568-214, 3.53 mm thick with an inner diameter of 25 mm) and press-cured at 180° C. for thirty minutes. The samples were then subjected to the Curing Procedure, including the Heat-Treatment Procedure. The compositions and results are shown in Table 5.

TABLE 5
Results for dry-blended compositions.

| | Gum-A | Perfluoroplastic | | | | |
|---|---|---|---|---|---|---|
| | Dry | | Dry | FT-IR peak (cm⁻¹) | | Surface |
| Sample | wt. % | I.D. | wt. % | Core | Surface | analysis |
| CE-10 | 80 | PFP-A | 20 | 1193 | 1192 | Glossy - Poor |
| CE-11 | 80 | PFP-D | 20 | 1193 | 1191 | Glossy - Poor |
| CE-12 | 80 | PFP-E | 20 | 1192 | 1191 | Glossy - Poor |

1. A method of making a fluoroelastomer article comprising
(i) molding a composition into a shape, the composition comprising a coagulated and dried latex blend comprising
(a) a perfluoro-elastomeric gum comprising, based on the total moles of repeat units in the gum, 0.5 to 4 mole % of repeat units of a curesite monomer, 46 to 80 mole % of tetrafluoroethylene repeat units, and 16 to 50 mole % of perfluoro ether repeat units selected from the group consisting of perfluorovinyl ethers, perfluoroallyl ethers, and combinations thereof, provided that the total amount of tetrafluoroethylene and perfluoro ether repeat units is at least 96 mole % of the total moles of repeat units in the perfluoro-elastomeric gum; and
(b) a perfluoroplastic having a melting point of at least 290° C., the perfluoroplastic comprising, based on the total moles of repeat units in the perfluoroplastic, at least 85 mole % tetrafluoroethylene repeat units, and 1.5 to 12 mole % of perfluoro ether repeat units selected from the group consisting of perfluorovinyl ethers, perfluoroallyl ethers, and combinations thereof;
(ii) curing the composition using one or more curing steps to form a cured structure comprising the cured perfluoroelastomer, wherein each curing step occurs at a curing temperature below the melting point of the perfluoroplastic; and
(iii) heat-treating the cured structure at a heat-treating temperature of at least 5° C. above the melting point of the perfluoroplastic for a heat-treating time of at least 5 minutes to form the fluoroelastomer article.

2. The method of claim 1, wherein the composition further comprises a curative for the perfluoro-elastomeric gum.

3. The method of claim 1, wherein the melting point of the perfluoroplastic is at least 300° C.

4. The method of claim 1, wherein the heat-treating temperature is at least 20° C. greater than the melting point of the perfluoroplastic, optionally wherein the heat-treating temperature is no more than 30° C. greater than the melting point of the perfluoroplastic.

5. The method of claim 1, wherein the heat-treating time is no greater than 60 minutes.

6. The method of claim 1, wherein the perfluoro-elastomeric gum comprises 20 to 40 mole % of the perfluoro ether repeat units.

7. The method of claim 1, wherein the perfluoro-elastomeric gum comprises repeat units of at least one perfluoroalkyl vinyl ether.

8. The method of claim 1, wherein the perfluoro-elastomeric gum comprises repeat units of at least one perfluoro ether selected from the group consisting of a perfluoroalkoxy vinyl ether, a perfluoroalkyl allyl ether, a perfluoroalkoxy allyl ether, and combinations thereof.

9. The method of claim 1, wherein the curesite monomer comprises at least one of an I, Br of nitrile cure-site group.

10. The method of claim 1, wherein the perfluoroplastic comprises 2 to 10 mole % of the perfluoro ether repeat units.

11. The method of claim 1, wherein the perfluoroplastic comprises repeat units of at least one perfluoroalkyl vinyl ether.

12. The method of claim 1, wherein the perfluoroplastic comprises repeat units of at least one perfluoroalkyl allyl ether.

13. The method of claim 12, wherein the perfluoroalkyl allyl ether is selected from the group consisting of perfluoromethyl allyl ether, perfluoroethyl allyl ether, perfluoropropyl allyl ether, and combinations thereof.

14. The method of claim 1, wherein the perfluoroplastic further comprises curesite monomer repeat units.

15. The method of claim 1, wherein the Z-average particle size of the particles of the fluoroplastic is no greater than 300 nanometers, as measured according to the Particle Size Method described in the present application.

16. The method of claim 15, wherein the Z-average particle size of the particles of the fluoroplastic is between 20 and 250 nanometers, as measured according to the Particle Size Method described in the present application.

17. A cured fluoroelastomer article formed by the method of claim 1.

18. A cured fluoroelastomer article having a core surrounded by surface, the article comprising
(a) a cured perfluoro-elastomeric gum comprising, based on the total moles of repeat units in the gum, 0.5 to 4 mole % of repeat units of a curesite monomer, 46 to 80 mole % of tetrafluoroethylene repeat units, and 16 to 50 mole % of perfluoro ether repeat units selected from the group consisting of perfluorovinyl ethers, perfluoroallyl ethers, and combinations thereof, provided that the total amount of tetrafluoroethylene and perfluoro ether repeat units is at least 96 mole % of the total moles of repeat units in the perfluoro-elastomeric gum; and
(b) a perfluoroplastic having a melting point of at least 290° C., the perfluoroplastic comprising, based on the total moles of repeat units in the perfluoroplastic, at least 85 mole % tetrafluoroethylene repeat units, and 1.5 to 12 mole % of perfluoro ether repeat units selected from the group consisting of perfluorovinyl ethers, perfluoroallyl ethers, and combinations thereof;
wherein the cured perfluoro-elastomeric gum and the perfluoroplastic are present through out the core of the article, the perfluoroplastic is present at the surface of the article, and the surface comprises dimples having an average diameter of 5 to 50 microns.
